(19) United States
(12) Patent Application Publication
(10) Pub. No.: US 2026/0168963 A1
(43) Pub. Date: Jun. 18, 2026

(54) MONITORING AND MAINTAINING THE MOLECULAR COMPOSITION OF A FLUID

(71) Applicant: PHILLIPS 66 COMPANY, HOUSTON, TX (US)

(72) Inventors: Tristan F. Kinde, Bartlesville, OK (US); Amin Baghalian, Metuchen, NJ (US); Charles S. Armstrong, Beaumont, TX (US); Alexandru Platon, Bartlesville, OK (US)

(73) Assignee: PHILLIPS 66 COMPANY, HOUSTON, TX (US)

(21) Appl. No.: 19/408,747

(22) Filed: Dec. 4, 2025

Related U.S. Application Data
(60) Provisional application No. 63/733,244, filed on Dec. 12, 2024.

(51) Int. Cl. G01N 29/024; G01N 1/14

(52) U.S. Cl. CPC G01N 29/024; G01N 1/14; G01N 2001/1463

(57) ABSTRACT

A process for rapidly determining the molecular composition of a fluid containing n molecular components based upon analysis of n−1 selected physical properties of the fluid. The process utilizes the relationship between each selected physical property and all possible concentrations of the n molecular components in the fluid (at a specific pressure and temperature) to develop a response surface for that physical property. For linear relationships each response surface produces a line at a specific measured value for that physical property. The intersection between the lines for each of the n−1 physical properties corresponds to the quantity of each molecular component in the fluid.

### STATEMENT REGARDING FEDERALLY SPONSORED RESEARCH OR DEVELOPMENT

This application is a non-provisional application that claims benefit under 35 USC § 119(e) to U.S. Provisional Application Ser. No. 63/733,244 filed on Dec. 12, 2024, titled “Monitoring and Maintaining the Molecular Composition of a Fluid,” which is incorporated herein in its entirety.

### FIELD OF THE INVENTION

The present invention relates to processes for rapidly determining the molecular composition of a fluid based upon analysis of selected physical properties.

### BACKGROUND

Analysis of fluid molecular composition is important in many industries, so it is essential that the task can be performed quickly, accurately, and inexpensively. Component concentration and blend optimization using traditional analyzers generally takes one of two paths: direct, calibrated measurement or association by modeling.

Traditional fluid composition analyzers can be expensive to purchase and maintain, which discourages widespread implementation. These costs include initial capital investment, installation, calibration, and routine maintenance. Model development often requires a significant time investment, and the resulting models often must be periodically updated to maintain accuracy.

To address these challenges, a robust and cost-effective alternative is needed that can provide accurate fluid composition data, be deployed across various applications without significant financial investment, and create new opportunities for process optimization beyond current scenarios. The present process utilizes neither models nor direct quantitative analysis of individual molecular components of a fluid, but relies instead on a series of linear correlations between certain physical properties of a fluid and its molecular composition.

### BRIEF SUMMARY

Some embodiments comprise a process for monitoring a fluid to maintain the concentration of at least one molecular component of the fluid within a defined range, the process comprising: (a) providing a fluid comprising at least two molecular components (n); (b) selecting at least two of the molecular components in the fluid to determine the concentration of each selected molecular component; (c) measuring at least one physical property of the fluid at a known temperature and a known pressure to produce at least one physical property measurement(s), wherein the number of physical properties measured is one less than the number of selected molecular components, wherein each physical property that is measured is distinct and correlates with the concentration of each selected molecular component; (d) determining the concentration of each selected molecular component by: calculating a mathematical response surface for each physical property measured in part (c), wherein each mathematical response surface represents a correlation between values for each physical property and potential concentrations of each of the selected molecular components in the fluid at a known temperature and a known pressure for the fluid, producing an algebraic expression for each response surface that represents the correlative relationship between each physical property measured in part (c) and the possible concentrations of each selected molecular component at each value for each physical property measured in part (c), finding the intersection between the response surface calculated for each physical property and the plane created by each physical property measurement of part (c) by setting the algebraic expression for each physical property equal to the corresponding physical property measurement to produce an algebraic equation, solving for the resulting system of equations to derive values for the variables that are true for all equations, to produce a value for each molecular component that corresponds to the concentration of that molecular component in the fluid; (e) comparing the concentration determined for each molecular component in (d) to a reference range of acceptable concentrations for that molecular component in the fluid; (f) increasing the flow from at least one source that operates to increase the concentration of a selected molecular component when the concentration for that molecular component, as determined in part (d), is lower than the reference range; (g) decreasing the flow from at least one source that operates to increase the concentration of a selected molecular component when the concentration for that component, as determined in part (d), is above the reference range.

In some embodiments, the concentration of an additional distinct molecular component of the fluid is inferred from the algebraic expression after the determining of part (d). In some embodiments, the at least one physical property that is measured is selected from density, soundwave propagation speed, viscosity, surface tension, boiling point, freezing point, refractive index, conductivity, pH, color and opacity, heat capacity, vapor pressure and solubility. In some embodiments, the known temperature is in a range wherein the fluid is in liquid phase. In some embodiments, the known pressure is in a range wherein the fluid is in liquid phase. In some embodiments, the temperature is in a range from 0 to 100 deg Celsius and the pressure is in the range from 1 to 100 Bara. In some embodiments, the at least one source is selected from an injector and a valve. In some embodiments, the physical properties are density and speed of soundwave propagation, and the molecular components are selected from hydrocarbons with a carbon number in the range from 1 to 30.

In some embodiments, each algebraic equation is a linear algebraic equation, wherein each response surface is a plane and wherein the intersection between the plane formed by each physical property measured in part (c) and the response surface calculated for that physical property in part (d) is a line. In some embodiments, the known temperature of the fluid and the known pressure of the fluid are each measured empirically.

The brief summary and background are not intended to identify essential aspects of the described subject matter, nor should they be used to constrict or limit the scope of the claims. For example, the scope of the claims should not be limited based on whether the recited subject matter includes any or all aspects noted in the general description and/or addresses any issue noted in the background.

### BRIEF DESCRIPTION OF THE FIGURES

A more complete understanding of the various embodiments may be acquired by referring to the following descriptions along with the accompanying drawings in which:

FIG. 1 depicts graphs showing examples of a response surface.

FIG. 2 depicts graphs showing the intersection of a physical property response surface with an empirically measured value for that physical property in a fluid.

FIG. 3 depicts graphs showing the intersection of a physical property response surface with an empirically measured value for that physical property in a fluid.

FIG. 4 depicts graphs showing the intersection between the lines produced by the intersection of a two physical property response surfaces and a measured value of that property in a fluid.

FIG. 5 is a flow diagram of an embodiment of the inventive processes and systems disclosed herein.

FIG. 6 depicts a graph showing the intersection of a physical property response surface with an empirically measured value for that physical property in a fluid.

FIG. 7 depicts a graph showing the intersection of a physical property response surface with an empirically measured value for that physical property in a fluid.

The inventive processes and systems may comprise various modifications and alternative forms, only some of which are illustrated in the drawings. The drawings may not be to scale.

### DETAILED DESCRIPTION

Fluid composition monitoring and blending optimization are critical parts of maximizing the profit of many industrial processes. The present process quickly calculates molecular composition by correlating basic physical property measurements of a fluid with its composition, then solving systems of linear equations that represent each correlation. The process operates to keep the fluid composition within a specified range (or blend ratio) for the various molecular components present in the fluid.

The present inventive process and system utilizes correlations between the physical properties of a fluid mixture and its molecular composition to calculate useful information about the fluid mixture, including characteristics such as molecular composition, the concentrations of various molecular components in a fluid mixture and aggregate physical properties of the fluid. A number of physical properties of a fluid may correlate with the molecular composition of the fluid and provide useful data. Most preferred are properties that can be quickly and non-invasively measured by analyzers that do not require direct contact with the fluid to be analyzed (e.g., density of the fluid and/or the speed of soundwave propagation through the fluid).

Some embodiments of the process and system comprise programming code that when executed, express an algorithm that operates to determine the concentration of selected molecular components of a fluid. First, the number of (n) molecular compounds to be determined in the fluid are selected. Next, the number of physical properties needed to determine the concentration of each of the selected molecular components is represented by the degrees of freedom (n−1) for the problem. In other words, the number of physical properties needed is one less than the number of selected molecular compounds (e.g., for three unknown compounds in the mixture, the degrees of freedom=3−1=2). Alternatively stated, the measurements of two physical properties of a fluid are needed for the algorithm to determine the concentration of the three molecular compounds of interest in the fluid.

The algorithm incorporates mathematical correlations that are developed between each of the (n−1) physical properties of the fluid and the concentration of one or more of the (n) molecular components in the product fluid. The mathematical relationship between each selected physical property and the concentration of each of multiple molecular components in the fluid is termed a response surface. Multiple response surfaces are created, with each response surface modeling the correlation between empirically measured values for a selected physical property of the fluid and all potential concentrations of molecular components in the fluid for each measured value of the selected physical property.

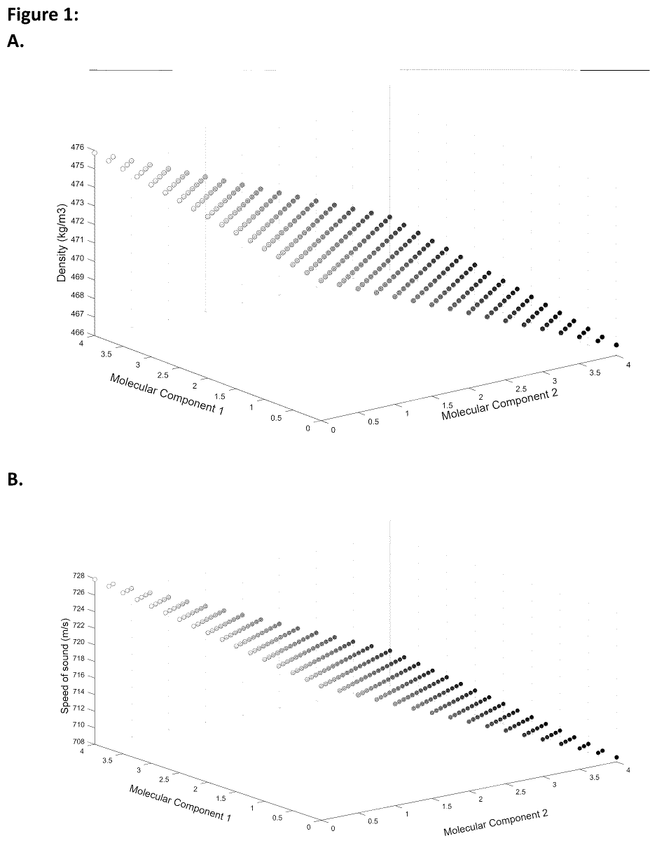

Each response surface is constrained to a specified range of temperatures and pressures that are relevant to the problem (i.e., the range of temperatures and pressures typically observed for the fluid) to produce a constrained response surface. The response surface is derived from a meta-model (i.e., a model that incorporates other models) for each selected physical property that incorporates measured values of each selected physical property versus all possible concentrations of one or more molecular components of the fluid over the constrained ranges of temperature and pressure. FIG. 1 shows that at a specific temperature and pressure of the fluid, a response surface is reduced to a planar response surface. FIG. 1A depicts a hypothetical example of this response surface showing the relationship between the density of a fluid the relationship between the density (z-axis) of a fluid and the concentrations of a first molecular component (y-axis) and a second molecular component (x-axis) in the fluid at a specific temperature and pressure for the fluid. FIG. 1B depicts a hypothetical example of a response surface showing the relationship between the speed of soundwave propagation in a fluid (z-axis) of a fluid and the concentrations of a first molecular component (y-axis) and a second molecular component (x-axis) in the fluid at a specific temperature and pressure for the fluid.

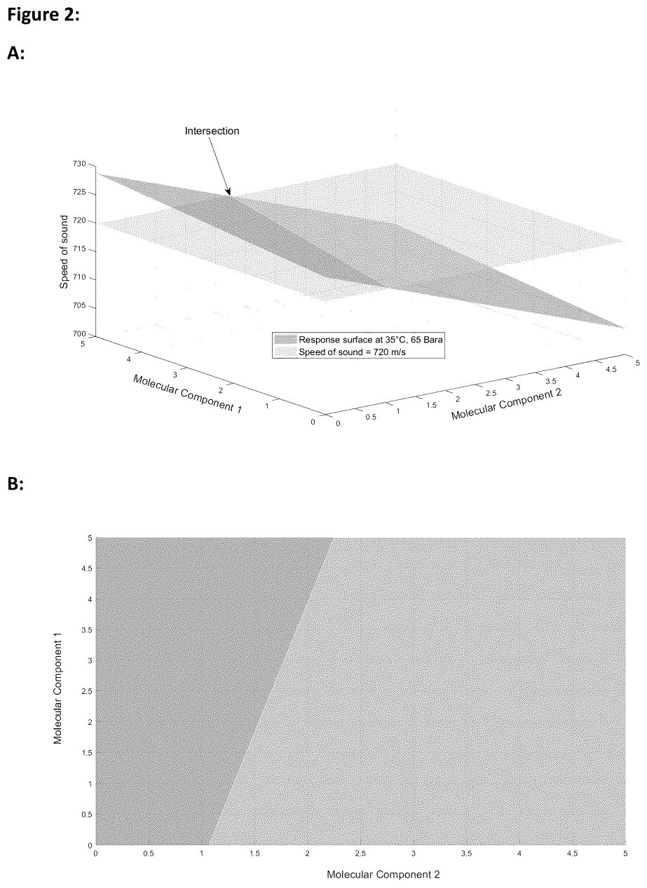

The combination of possible concentrations of the molecular components are represented by a line that is formed by the intersection of the planar response surface for each physical property and a second plane representing an empirical measurement of that physical property in the fluid. FIG. 2A depicts a hypothetical example of such an intersection where the physical property is the speed of soundwave propagation in a fluid. An inclined planar response surface for the speed of soundwave propagation in the fluid is intersected by a second horizontal plane representing an empirical measurement of the speed of soundwave propagation in the fluid. FIG. 2B depicts the intersection between the two planes from above (viewpoint parallel to the z-axis). The algebraic expression representing the line is determined by finding the solution wherein the equation is equal to the physical property measurement.

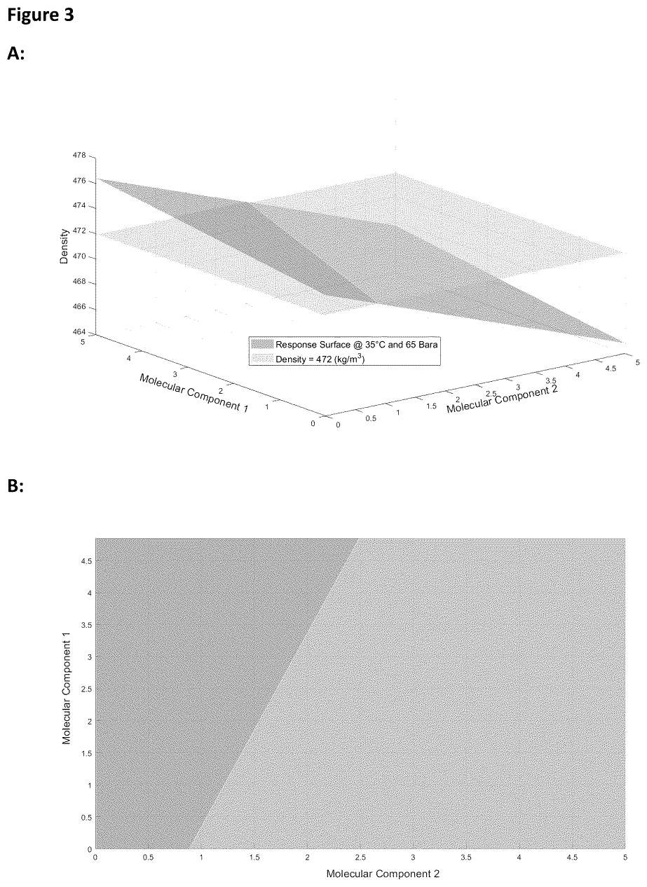

Similarly, FIG. 3A depicts a hypothetical example of such an intersection where the physical property is the density of a fluid. An inclined planar response surface for the density in the fluid is intersected by a second horizontal plane representing an empirical measurement of the density of the fluid. FIG. 3B depicts the intersection between the two planes from above (viewpoint parallel to the z-axis). The algebraic expression representing the line is determined by finding the solution wherein the equation is equal to the physical property measurement.

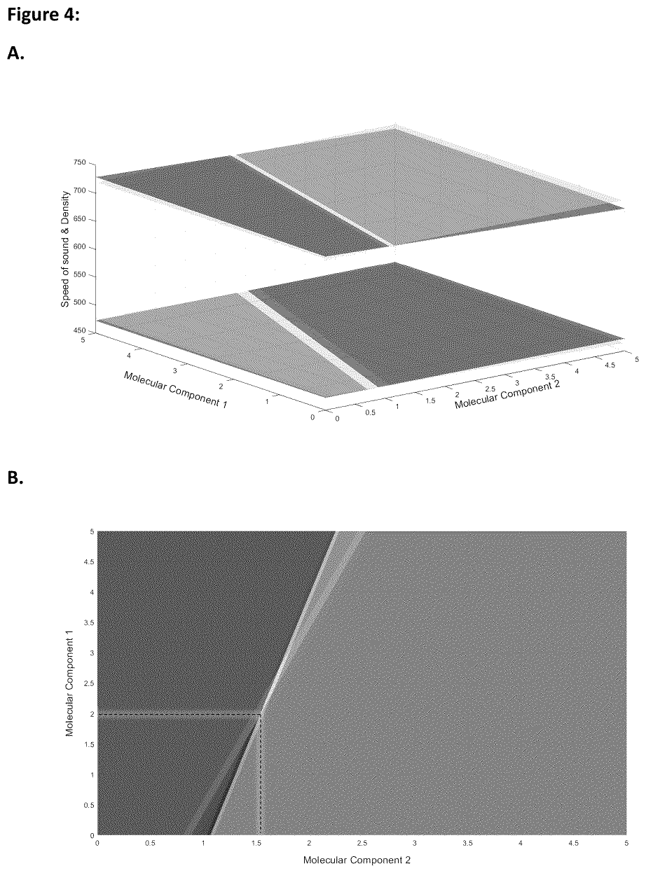

This process is repeated for each n−1 physical property, producing a linear equation for each that represents an intersection between the produced response surface for a given physical property and the corresponding measured value for that physical property. Once this is completed, the exact percentage of each molecular component in the fluid can be determined by solving for the system of linear equations produced for the n−1 physical properties. In essence, the process solves for the intersection between the multiple linear equations that were produced via the process described above. FIG. 4A illustrates this concept by stacking the intersections of planes for the hypothetical examples depicted in FIGS. 2 and 3. The solution to the system of equations is the intersection of all the linear equations, or the single point where the possible concentrations of all molecular components is simultaneously valid for all equations (depicted in FIG. 4B). In other words, the intersection (where the dotted lines meet in FIG. 4B) represents the concentration of each of the molecular components in the fluid as determined by the process.

Once the concentration of each of the molecular components in the fluid is determined, the concentration of each molecular component is compared to a reference range for that molecular component, where each reference range represents minimum and maximum acceptable concentrations of that component in the fluid. This determination can be made either manually or may be performed by a programmable logic controller comprising a processor and memory that contains software comprising an algorithm that when executed by the processor determines whether the concentration of each molecular component is within its reference range. For each molecular component determined to be outside of its predefined reference range, the process adjusts the concentration of that molecular component to be with the reference range. This may be accomplished either via the manual or automated control of a valve or injector that regulates the flow for a source comprising that molecular component. Automated control may be in the form of a control system that comprises one or more programmable logic controllers.

The process and system described herein comprises solving systems of equations that describe the relationship between the observed physical properties and the molecular composition of the fluid. If the correlation is linear in nature, the solution (i.e., the concentration of each selected molecular component in the fluid) is obtained by solving systems of simple linear algebraic equations. However, in certain embodiments, the relationship between one or more physical properties and the molecular composition of the fluid is not linear. In these embodiments, more complex mathematics are utilized to describe the relationship and to solve for the system of equations produced by the intersection of each physical property measurement and all possible molecular compositions for a given measurement value of that physical property. If the relationship is non-linear, it may be described mathematically in an alternative manner, such as via a spline equation or polynomial equation. In such embodiments, the solution would be to set all equations in the system equal to each other and find the values for each variable that satisfies all equations. This process can be quickly repeated on an intermittent basis, a nearly continuous basis, or a continuous basis, enabling advanced monitoring and control of all selected molecular components of the product fluid.

In some cases, especially when dealing with complex correlations, the equations used to represent the correlation might not be solvable analytically. In such scenarios, numerical methods can be used that may include (but are not limited to):
Newton-Raphson Method: An iterative method for finding roots of equations.
Bisection Method: A bracketing method that repeatedly bisects an interval, then selects a subinterval in which a root must lie.
Secant Method: An iterative method similar to the Newton-Raphson method that does not require the computation of derivatives.

Current methods for fluid compositional analysis often rely upon analyzers that are expensive to install and maintain. In contrast, many of the analyzers useful with the present process are relatively inexpensive to install and maintain. Non-limiting examples of analyzer categories that may provide useful data for at least some embodiments of the inventive processes described herein include temperature probes, viscometers, density analyzers, conductivity analyzers, pressure sensors, boiling point analyzers, pH meters, visible and ultraviolet spectrophotometers, mass-flow controllers, vapor pressure and vapor-liquid ratio analyzers, acoustic analyzers, solubility testers, etc. Embodiments that utilize acoustic analysis take advantage of the non-intrusive and rapid nature of this analysis, and some embodiments that utilize acoustic analysis may simply correlate the speed of propagation of a soundwave through the fluid.

For embodiments that utilize a density measurement, a variety of analyzers that measure density are known in the art. A non-limiting list of such analyzers commonly used to determine the density of a fluid are hydrometers, digital density meters (also called specific gravity meters), and pycnometers. Hydrometers are simple, inexpensive devices consisting of a weighted glass bulb with a graduated stem that floats in the liquid, with the level at which it floats indicating the density based on a calibrated scale. Digital Density Meters are a more precise instrument that uses oscillation technology to measure the density of a liquid by detecting the change in vibration frequency of a hollow tube filled with the sample. Pycnometers typically comprise a specialized glass flask with a precisely known volume used to determine density by measuring the mass of a known volume of liquid.

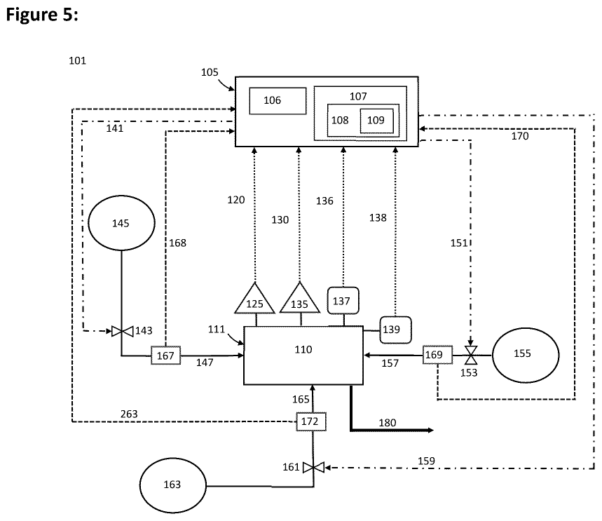

In an embodiment depicted in FIG. 5, a control system 101 comprises at least one programmable logic controller 105 that in turn comprises a computer processor 106 and memory 107 containing programming 108 that when executed by the processor 106 controls blending of a product fluid 110 in container 111. The programmable logic controller 105 receives a first physical property measurement 120 of a product fluid 110 in container 111 from a first analyzer 125. Similarly, the programmable logic controller 105 receives a second physical property measurement 130 of product fluid 110 from a second analyzer 135. The programmable logic controller 105 also receives a fluid temperature measurement 136 from a temperature sensor 137 that measures the temperature of the product fluid 108 and a fluid pressure measurement 138 from a pressure sensor 139 that measures the pressure of the product fluid 110. The programming 108 that is executed by the processor 106 calculates the concentration of three (n) molecular components in the product fluid 110 based upon an algorithm 109 that considers the first physical property measurement and the second physical property measurements as well as the temperature and pressure of the product fluid 110. Measurements of temperature and pressure of the product fluid are incorporated by the algorithm 109 to better correlate each physical property measurement with possible concentrations of the molecular components, thereby providing a more accurate determination of the concentration of each.

Once the concentration of each of the molecular components in the product fluid 110 is determined, the programming 108 executed by the programmable logic controller 105 next compares the calculated concentration for each molecular component to a reference range of acceptable concentrations for that molecular component that are held in memory 107. If the concentration of the first molecular component in product fluid 110 is less than the smallest concentration value in the reference range for the first molecular component, the programmable logic controller 105 sends a signal 141 to a first valve or injector 143 that controls flow from a first molecular component source 145 to increase the rate of flow of the first molecular component 147 to mix with the product fluid 110. This continues until subsequent iterations of the process determine that the concentration of first molecular component 147 in the product fluid 110 is within the reference range for that component. Similarly, if the concentration of the first molecular component in the product fluid 110 is determined to be greater than the highest value in the reference range for the first molecular component, the programmable logic controller 105 sends a first signal 141 to the first valve (or injector) 143 to decrease the rate of flow of the first molecular component 147 from the first molecular component source 145 until later iterations of the process determine that the concentration of the first molecular component in the product fluid 110 is within the reference range.

A similar procedure is followed by the programmable logic controller for the second molecular component. If the concentration of the second molecular component in product fluid 110 is less than the smallest concentration value in the reference range for the second molecular component, the programmable logic controller 105 sends a signal 151 to a second valve (or injector) 153 that controls flow from a second molecular component source 155 to increase the rate of flow of the second molecular component 157 to mix with the product fluid 110. This continues until subsequent iterations of the process determine that the concentration of second molecular component in the product fluid 110 is within the reference range for that component. Similarly, if the concentration of the second molecular component in the product fluid 110 is determined to be greater than the highest value in the reference range for the second molecular component, the programmable logic controller 105 sends a second signal 151 to the second valve or injector 153 to decrease the rate of flow of the second molecular component 157 from the second molecular component source 155 until later iterations of the process determine that the concentration of the second molecular component in the product fluid 110 is within its reference range.

A similar procedure is followed by the programmable logic controller for the third molecular component. If the concentration of the third molecular component in product fluid 110 is less than the smallest concentration value in the reference range for the second molecular component, the programmable logic controller 105 sends a third signal 159 to a third valve (or injector) 161 that controls flow from a third molecular component source 163 to increase the rate of flow of the third molecular component 165 to mix with the product fluid 110. This continues until subsequent iterations of the process determine that the concentration of third molecular component in the product fluid 110 is within the reference range for that component. Similarly, if the concentration of the third molecular component in the product fluid 110 is determined to be greater than the highest value in the reference range for the third molecular component, the programmable logic controller 105 sends a signal 159 to the third valve or injector 161 to decrease the rate of flow of the third molecular component 165 from the third molecular component source 163 until later iterations of the process determine that the concentration of the third molecular component in the product fluid 110 is within its reference range.

Each valve may comprise a valve controller (or valve positioner) that accurately and precisely controls the degree of opening for the valve it controls, thereby regulating the flow rate from each source to produce the proper ratio of molecular components that comprise the product fluid. In the embodiment depicted in FIG. 1, the material, or molecular component flowing from each molecular component supply may be maintained at a constant known pressure to allow more precise rate of flow past each valve when the valve is opened to a specific degree or percentage (e.g., from 1% to 100%), thereby allowing implementation of the desired ratio of molecular components by the programmable logic controller 105 based upon these known pressures.

Each valve is preferably of a design that accurately regulates flow through the valve when adjusted by a controller or positioner that may comprise a butterfly valve, a gate valve, an orifice valve or any other valve capable of accurately and precisely regulating flow. In the present embodiment, the flow of one or more molecular components to blend with the fluid is controlled by an injection valve. The butane injection valve may provide butane in either a continuous manner or via periodic injections sufficient for a given batch of finished gasoline that meets all vapor pressure and other required volatility specifications.

Some embodiments may alternatively analyze the volumetric flow rate of one or more of the molecular components (147, 157, 165) to control for potential variations in the supply pressure of each molecular component. In such embodiments, each molecular component may have a constant volumetric flow rate or a variable volumetric flow rate that is monitored by a flow meter to measure liquid flow of each molecular component at a location between each valve and receptacle 111. In the embodiment depicted in FIG. 5, a first flow meter 167 measures the flow rate of the first molecular component 147 at a location immediately downstream from the first valve 143. First flow meter 167 sends a flow rate signal 168 to programmable logic controller 105. A second flow meter 169 measures the flow rate of the second molecular component 157 at a location immediately downstream from the second valve 153. Second flow meter 169 sends a second flow rate signal 170 to programmable logic controller 105. A third flow meter 172 measures the flow rate of the third molecular component 165 at a location immediately downstream from the third valve 161. Third flow meter 172 sends a flow rate signal 173 to programmable logic controller 105. Speaking generally, each flow meter may be selected from a variety of conventional metering devices that include, but are not limited to, Corolis flow meters, magnetic flow meters, ultrasonic flow meters, vortex flow meters and differential pressure flow meters.

Programable logic controller 105 receives each flow rate measurement, and algorithm 109 considers each flow rate measurement to assist in more precise control when sending at least one signal to adjust the degree or percentage (i.e., 1-100%) to which a valve is opened to allow flow of a given molecular component. Each valve is preferably of a design that accurately regulates flow through the valve when adjusted by a controller or positioner that may comprise a butterfly valve, a gate valve, an orifice valve, injection valve, or any other valve capable of accurately and precisely regulating flow. Valves may be controlled to provide a given molecular component in either a continuous manner or via periodic injections sufficient for a given batch of fluid held in a receptacle.

Referring again to FIG. 1, the product fluid 110 is held or contained within container 111 and is removed from container 111 via pipe 180. Some embodiments do not comprise container 111 and instead comprise constant flow from one or more molecular component source(s) into pipe 180. Speaking generally, in some embodiments analysis of the product fluid by analyzers, temperature sensors, and pressure sensors is performed at a location that is downstream from the addition of the molecular components to the product fluid flowing through the pipe or conduit.

There are many useful variations of the present inventive process. Some non-limiting examples of specific industrial applications for the process may include controlling the vapor pressure of a fluid within a specified range, controlling the octane number of a fluid within a specified range, controlling the blending of butane and/or ethanol into a BOB (blendstock for oxygenate blending) to produce a finished gasoline, controlling the blending of ethane with propane in an appropriate ratio to produce an EP mix for plastics production, controlling acid concentration (e.g., hydrofluoric acid, sulfuric acid, etc.) in an alkylation process, controlling water content fuels in and other hydrocarbon streams, in situ monitoring and control of amine (or caustic) strength, monitoring and control of layers in a petroleum refining desalter (i.e., aqueous layer, rag layer, oil layer), monitoring and controlling brine strength in a desalter, monitoring and controlling crude oil properties and contaminant content in a conduit or tank (e.g. density, water content, chloride content, solids content, etc.), monitoring and controlling water recovery from a delayed coker unit, monitoring and controlling wax deposition in crude storage tanks, monitoring hydrotreater feed contamination (e.g., water, unwanted hydrocarbons, etc.).

### EXAMPLES

The following non-limiting examples are provided to further illustrate aspects described herein. However, the examples are not intended to be all-inclusive and are not intended to limit the scope of the aspects described herein. The particular materials and amounts thereof, as well as other conditions and details recited in these examples should not be used to limit the implementations described herein.

### Example

A first example embodiment of the process and system determines the concentrations of ethane and isobutane (i-butane) in a hydrocarbon fluid that predominantly comprises propane. Known parameters for the fluid mixture include temperature, pressure, density, and speed of soundwave propagation thorough the fluid. The problem has three unknown molecular components (e.g., propane, i-butane, and ethane) n, and therefore (n−1) two degrees of freedom. For this scenario, two easily measured physical properties of the mixture are density and speed of soundwave propagation. Thus, these two properties were selected to determine the concentration of each molecular compound in the fluid. The temperature of the fluid mixture was in the range from 20° C. to 51° C. and pressure of the fluid mixture was in the range from 60 Bara to 80 Bara.

### Response Surface for Soundwave Propagation Speed

First, data for the speed of soundwave propagation in the fluid was obtained for fluids that each contained only one hydrocarbon selected from propane, ethane and isobutane at temperatures ranging from 20° C. to 51° C. and pressures ranging from 60 Bara to 80 Bara. This was accomplished by sending a windowed sine wave signal via a piezoelectric actuator (PZA) bonded to the outer surface of a pipe containing the fluid. The signal wavelength sent by the PZA in this example was 4 MHz, but alternate signal wavelength frequencies could be used successfully depending on wave propagation properties of the fluid. The signal voltage was amplified to 100 volts to increase the signal to noise ratio. A portion of the signal was received by a piezoelectric sensor positioned on the outer surface of the pipe at an orientation of approximately 180 degrees relative to the piezoelectric actuator. The placement position of the piezoelectric sensor could vary based upon necessity of the individual application and to retain proper function as a signal receiver. The speed of soundwave propagation was measured based on the time for the sine wave to travel from the piezoelectric actuator to the piezoelectric sensor and the known distance between them.

At the pressures utilized, each hydrocarbon was in liquid phase and the soundwave propagation speed in each hydrocarbon fluid was observed to correlate directly with pressure and inversely with temperature. Therefore, empirical measurements of both pressure of the fluid and temperature of the fluid were utilized by the algorithm of the present invention to calculate the concentration of each light hydrocarbon in the fluid more accurately.

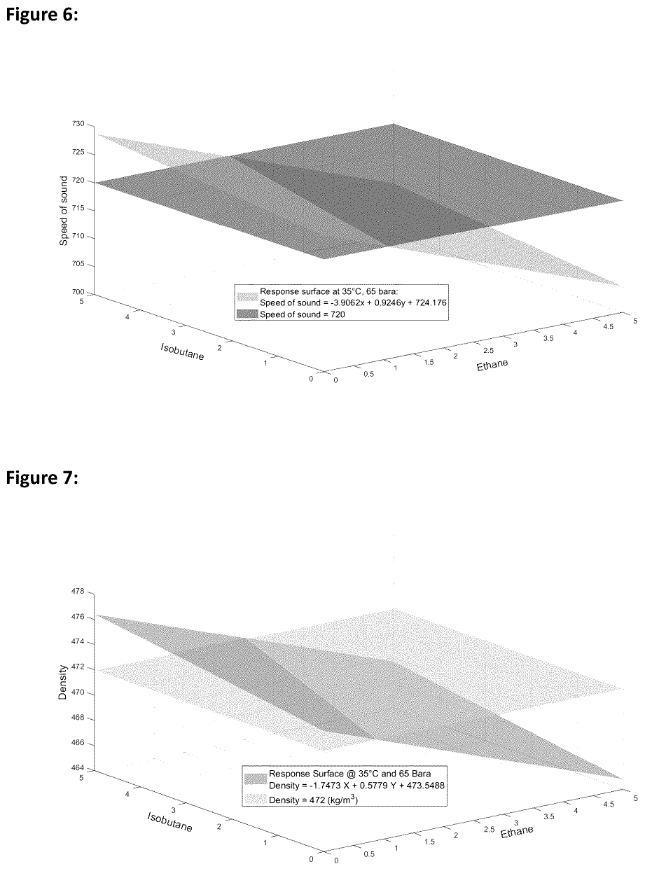

For a fluid comprising light hydrocarbons, the linear correlation between each selected physical property (i.e., density and speed of soundwave propagation) and all possible concentrations of ethane and isobutane in the fluid forms a plane at a specific temperature and pressure. FIG. 6 depicts the resulting response surface for speed of soundwave propagation (speed of sound) in the hydrocarbon fluid (z axis) when the hydrocarbon fluid comprises up to 4 wt. % ethane (x axis) and 4 wt. % isobutane (y axis). This response surface was limited to an empirically measured fluid temperature of 35 deg C. and a fluid pressure of 65 Bara. An empirical measurement of the speed of soundwave propagation through the hydrocarbon fluid was determined to be 720 meters/sec, represented as a second plane that intersects with the response surface to form a line. This line represents all possible concentrations of ethane and isobutane in the hydrocarbon fluid (within the ranges of 0-4 wt. % of each hydrocarbon) at the measured soundwave speed. Mathematically, this line was represented by the linear equation:

Speed of sound=3.9062x+0.9246y+724.1760

Speed of sound=720 m/s

### Response Surface for Density

Next, density information for propane, ethane, and isobutane was obtained for the temperature and pressure ranges listed above. This information was available from the National Institutes for Standards and Technology Web Handbook but could also have been determined empirically via routine analysis. At these pressures, each hydrocarbon is in liquid phase and the density of each hydrocarbon correlates directly with pressure and inversely with temperature. At a specific temperature and pressure, the response surface is reduced to a plane for each of these physical properties.

A resulting response surface for density of the hydrocarbon fluid (in kg/m³) at a temperature of 35 deg C. and 65 Bara and is shown in FIG. 7. The density response surface (201) displays the density (z axis) of the hydrocarbon fluid for all concentrations of up to 4 wt. % ethane (x axis) and 4 wt. % isobutane (y axis).

An empirical measurement of the density in the hydrocarbon fluid using conventional analytical methods and equipment was determined to be 472 kg/m³. This measurement produces a second plane that extends horizontally and intersects with the density response surface to form a line representing all possible concentrations of ethane and isobutane in the hydrocarbon fluid (within the ranges of 0-4 wt. % of each hydrocarbon) at the measured density. Mathematically, this line was represented by the linear equation:

Density=1.7473x+0.5779y+473.5488.

Density=472 kg/m³

Solving for this system of two equations (i.e., soundwave speed and density) comprises finding values for each variable that satisfies both linear equations. The value determined for each variable is the calculated concentration of ethane and isobutane in the hydrocarbon fluid. This solution is represented graphically as the intersection point of the lines determined for speed of soundwave propagation in FIG. 6 and density in FIG. 7. The intersection point is the only concentration value for each of ethane and isobutane that satisfies both linear equations (at the empirically measured temperature and pressure) for the measured variables density and speed of soundwave propagation. In this example, the fluid comprised only three light hydrocarbons, so the concentration of propane was easily determined by subtracting the derived concentrations of ethane and isobutane from 100 percent.

In a commercial setting, the concentrations derived for each molecular component would be compared to reference ranges of acceptable concentrations for each in the product fluid. If the concentration of one or more molecular components was below the reference range, the rate of flow would be increased from a valve or injector that regulates the rate of flow of that molecular component into the product fluid until subsequent iterations of the process determine that the molecular component is within the reference range. Conversely, if the concentration of one or more molecular components was below the reference range, the rate of flow would be decrease from a valve or injector that regulates the rate of flow of that molecular component into the product fluid until subsequent iterations of the process determine that the molecular component is within the reference range. Control of each valve or injector could be performed manually but preferably would be controlled by a control system comprising at least one programmable logic controller.

In some embodiments, a programmable logic controller can include a computer processor coupled to a memory [e.g., random access memory (or “RAM”), read only memory, (or “ROM”) etc., that can store program code (or programming) comprising one or more algorithm(s) that when executed by the computer processor controls the position of one or more valves that receive operational signals from the programmable logic controller, where each valve controls the rate of flow from a source that comprises at least one molecular component to a blending receptacle that may be a storage vessel, pipeline, etc. The program code is executed by the processor to calculate the proper flow of each selected molecular component to form a product fluid mixture that comprises each molecular component at a concentration that is within a predetermined acceptable range. The program code receives measurements of one or more selected physical properties and also may receive measurements that correct physical property measurements for the effects of fluid pressure and fluid temperature. In some embodiments, data received from sensors that measure pressure and the temperature for the fluid may be incorporated into the algorithm that is executed by the processor of the programable logic controller. Information representing desirable or predetermined concentrations for each molecular component may be supplied as inputs to the program code.

Computers and controller embodiments herein may feature routines, program code, objects, components, data structures, and their equivalents to perform particular tasks or implement control or determination operations. Computer executable instructions, associated data structures, and program modules represent examples of the program code means for executing acts of the methods disclosed herein. Computing devices within certain embodiments may include general or more specific computing systems, which may include: a processing unit, a system memory, and a system bus that couples various system components including the system memory to the processing unit. Processing units can execute computer-executable instructions designed to implement features of computer system, including features of the present invention. The system bus may be any of several types of bus structures including a memory bus or memory controller, a peripheral bus, and a local bus using any of a variety of bus architectures. The system memory includes solid-state read only memory (“ROM”) and random access memory (“RAM”). A basic input/output system (“BIOS”), containing the basic routines that help transfer information between elements within computer system, such as during start-up, may be stored in ROM.

The computer system may also include hard disk drive (or other storage media such as a solid-state disk) for reading from and writing to hard disk, disk drive for reading from or writing to removable disk, and optical disk drive for reading from or writing to removable optical disk, such as, for example, a CD-ROM or other optical media. The hard disk drive, disk drive, and optical disk drive may be connected to the system bus by hard disk drive interface, disk drive-interface, and optical drive interface, respectively. The drives and their associated computer-readable media provide nonvolatile storage of computer-executable instructions, data structures, program modules, and other data for the computer system. Although the example environment described herein employs hard disk, removable disk and removable optical disk, other types of computer readable media for storing data can be used. In some embodiments, the computer system may be connectable to computer networks, such as, for example, an office-wide or enterprise-wide computer network, an intranet, and/or the Internet. Computer system can exchange data with external sources, such as, for example, remote computer systems, remote applications, and/or remote databases over such computer networks. In some embodiments, a computer system may include network interface, through which computer system receives data from external sources and/or transmits data to external sources. The network interface facilitates the exchange of data with remote computer system. Network interface can logically represent one or more software and/or hardware modules, such as, for example, a network interface card and corresponding Network Driver Interface Specification (“NDIS”) stack. Similarly, in some embodiments, the computer system includes input/output interface, through which the computer system receives data from external sources and/or transmits data to external sources.

In some embodiments, program code comprising one or more program modules may be stored on hard disk, disk drive, optical disk, ROM or RAM, including an operating system, one or more application programs, other program modules, and program data. In one embodiment, a user may enter commands and information into computer system through keyboard, pointing device, or other input devices, such as, for example, a microphone, joystick, game pad, scanner, or the like. These and other input devices can be connected to the processing unit through input/output interface coupled to system bus. Input/output interface logically represents any of a wide variety of different interfaces, such as, for example, a serial port interface, a PS/2 interface, a parallel port interface, a Universal Serial Bus (“USB”) interface or may even logically represent a combination of different interfaces.

In some embodiments, a monitor or other display device may also be connected to system bus via video interface. Other peripheral output devices, such as, for example, printers, can also be connected to computer system.

A control system may include one or more controllers and may optionally be connected to one or more sensors such as flow rate monitors (meters) and temperature monitors. These connections may take place via wired or wireless communications systems. Alternatively, these connections may take place via pneumatic linkage, magnetic connection, or through other methods known in the art. A control system may include a combination of software and hardware within a network to balance the industrial infrastructure. In some embodiments, control systems may include one or more of the following: as programmable logic controllers (PLCs), supervisory control and data acquisition (SCADA), industrial automation and control systems (IACS), remote terminal units (RTUs), intelligent electronic devices (IEDs) control severs, and sensors. PLCs are capable of performing various industrial applications with inbuilt modules like power supply, CPU, I/O modules, and other communication modules. The PLCs can be integrated or modular. A modular PLC is compact and fixed with limited I/O functions, whereas integrated PLC extends 1/O modules based on its features. The input module may be connected with sensors, while actuators or other output devices are optionally connected with the output module.

SCADA systems may be used for monitoring long-distance field sites through a centralized mechanism. They generally contain devices such as PLCs or other commercial hardware modules to be distributed in various locations. They are known to provide capabilities of supervision at the supervisory level.

Distributed control systems (DCS) may also be employed. These systems are typically used to control productions in one location. The desired set point is maintained to be sent to the controller or actuator instructing valves. This data may be retained for future references or used in advanced control strategies. A supervisory control loop may be used by each DCS to manage multiple local devices or controllers. Furthermore, a DCS is capable of eliminating the impact of a single fault on the whole system.

In a scenario where more than one programmable logic controller is implemented in a control system, the more than one controller can be interconnected with other controls, or the more than one controller can be independent from other controllers. A variety of control systems may be featured in the embodiments. The embodiments can be realized in hardware, software, or a combination of hardware and software. Embodiments can be realized in a centralized fashion in one computer system, or in a distributed fashion where different elements are spread across several interconnected computer systems. Any kind of computer system, or other apparatus adapted for carrying out the methods described herein, is suited to perform the functions described herein.

Some of the most common equipment useful in various embodiments are pipes, valves, meters, sensors, and pumps, but there are well understood by those having experience in the field of technology. Storage tanks and pipes, usually made of steel with welded joints, may contain and/or transport one or more of the molecular components to be mixed and/or blended with the fluid. Valves are used throughout the system to control the flow of at least one molecular component and or the product fluid. Meters measure the flow rate of various molecular components and/or fluids and controllers regulate the flow rate of molecular components and/or fluids to ensure a product fluid where all molecular components are within their reference range for concentration. Pumps may move molecular components or product fluid and also may serve to compress molecular components that are in a gaseous state. Controllers are implemented at various points in the system to receive operational inputs (e.g., desired ratios, flowrates, volumes, temperatures, pressures, chemical compositions, soundwave propagation speed and other measured physical properties) and the controllers may also control system implementations such as valves, pumps and other operational equipment for desired outputs. Flow meters (monitors) in the embodiments herein may include oval gear meters, orifice-square edge, orifice-conic edge, venturi, pitot tube, electromagnetic, turbine, ultrasonic-transient time, Doppler, rotometer, vortex, or Coriolis flow meters. Flow meters may also include ultrasonic or ultrasound flow meters, intrusive or humidified flow meters, venturi channels, overflow plates, radar flow meters, Coriolis flow meters, differential pressure flow meters, magnetic inductive flow meters and other types of flow meters. It is understood that other suitable flow meters known to those skilled in the art may also be used. The control system may include controllers, meters or sensors, pumps, valves, wiring or wireless connection/connectivity components, computers, and other components to control the flow of fluids.

The descriptions of the various aspects of the present disclosure have been presented for purposes of illustration but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects disclosed herein. While the foregoing is directed to aspects of the present disclosure, other and further aspects of the present disclosure can be devised without departing from the basic scope thereof.

### Illustrative Embodiments

The following is a description of various embodiments of the disclosed subject matter. Each embodiment may include one or more of the various features, characteristics, or advantages of the disclosed subject matter. The embodiments are intended to illustrate a few aspects of the disclosed subject matter and should not be considered a comprehensive or exhaustive description of all possible embodiments.

One illustrative embodiment comprises a process for monitoring a fluid to maintain the concentration of at least one molecular component of the fluid within a defined range, the process comprising: (a) providing a fluid comprising at least two molecular components (n); (b) selecting at least two of the molecular components in the fluid to determine the concentration of each selected molecular component; (c) measuring at least one physical property of the fluid at a known temperature and a known pressure to produce at least one physical property measurement, where the number of physical properties measured is one less than the number of selected molecular components, where each physical property that is measured is distinct and correlates with the concentration of each selected molecular component; (d) determining the concentration of each selected molecular component by: calculating a mathematical response surface for each physical property measured in part (c), where each mathematical response surface represents a correlation between values for each physical property and potential concentrations of each of the selected molecular components in the fluid at a known temperature and a known pressure for the fluid, producing an algebraic expression for each response surface that represents the correlative relationship between each physical property measured in part (c) and the possible concentrations of each selected molecular component at each value for each physical property measured in part (c), finding the intersection between the response surface calculated for each physical property and the plane created by each physical property measurement of part (c) by setting the algebraic expression for each physical property equal to the corresponding physical property measurement to produce an algebraic equation, solving for the resulting system of equations to derive values for the variables that are true for all equations, to produce a value for each molecular component that corresponds to the concentration of that molecular component in the fluid; (e) comparing the concentration determined for each molecular component in (d) to a reference range of acceptable concentrations for that molecular component in the fluid; (f) increasing the flow from at least one source that operates to increase the concentration of a selected molecular component when the concentration for that molecular component, as determined in part (d), is lower than the reference range; (g) decreasing the flow from at least one source that operates to increase the concentration of a selected molecular component when the concentration for that component, as determined in part (d), is above the reference range.

An embodiment of the above-described process where the concentration of an additional distinct molecular component of the fluid is inferred from the algebraic expression after the determining of part (d).

An embodiment of the above-described process where the at least one physical property that is measured is selected from density, soundwave propagation speed, viscosity, surface tension, boiling point, freezing point, refractive index, conductivity, pH, color and opacity, heat capacity, vapor pressure and solubility.

An embodiment of the above-described process where the known temperature is in a range wherein the fluid is in liquid phase.

An embodiment of the above-described process where the known pressure is in a range wherein the fluid is in liquid phase.

An embodiment of the above-described process where the temperature is in a range from 0 to 100 deg Celsius and the pressure is in the range from 1 to 100 Bara.

An embodiment of the above-described process where the at least one source is selected from an injector and a valve.

An embodiment of the above-described process where the physical properties are density and speed of soundwave propagation, and the molecular components are selected from hydrocarbons with a carbon number in the range from 1 to 30.

An embodiment of the above-described process where each algebraic equation is a linear algebraic equation, where each response surface is a plane, and where the intersection between the plane formed by each physical property measured in part (c) and the response surface calculated for that physical property in part (d) is a line.

An embodiment of the above-described process where the known temperature of the fluid and the known pressure of the fluid are each measured empirically.

An embodiment of the above-described process where any individual limitation of the process listed in the preceding paragraphs is present in combination with any other individual limitation of the process described in the preceding paragraphs.

### General Terminology and Interpretative Conventions

Any methods described in the claims or specification should not be interpreted to require the steps to be performed in a specific order unless expressly stated. The methods should be interpreted to provide support to perform the recited steps in any order unless expressly stated otherwise.

Certain features described in the context of separate embodiments can also be implemented in combination in a single embodiment. Conversely, various features that are described in the context of a single embodiment can also be implemented in multiple embodiments separately or in any suitable sub-combination. Moreover, although features may be described above in certain combinations and even initially claimed as such, one or more features from a claimed combination can be excised from the combination, and the claimed combination may be directed to a sub-combination or variation of a sub-combination.

The example configurations and embodiments described in this document do not represent all the examples that may be implemented or that are within the scope of the claims. The term “example” shall be interpreted to mean “serving as an example, instance, or illustration,” and not “preferred” or “advantageous over other examples.”

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The phrase “based on” shall be interpreted to refer to an open set of conditions unless unequivocally stated otherwise (e.g., based on only a given condition). For example, a step described as being based on a given condition may be based on the recited condition and one or more unrecited conditions.

The terms have, having, contain, containing, include, including, and characterized by should be interpreted to be synonymous with the terms comprise and comprising—i.e., the terms are inclusive or open-ended and do not exclude additional unrecited subject matter. The use of these terms should also be understood as disclosing and providing support for narrower alternative embodiments where these terms are replaced by “consisting of,” “consisting of the recited subject matter plus impurities and/or trace amounts of other materials,” or “consisting essentially of.”

Unless otherwise indicated, all numbers or expressions, such as those expressing dimensions, physical characteristics, or the like, used in the specification (other than the claims) are understood to be modified in all instances by the term “approximately.” At the very least, and not as an attempt to limit the application of the doctrine of equivalents to the claims, each numerical parameter recited in the specification or claims that is modified by the term “approximately” should be construed in light of the number of recited significant digits and/or by applying ordinary rounding techniques.

All disclosed ranges are to be understood to encompass and provide support for claims that recite any subranges, or any individual values subsumed by each range. For example, a stated range of 1 to 10 should be considered to include and provide support for claims that recite any sub-ranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth), which values can be expressed alone or as a minimum value (e.g., at least 5.8) or a maximum value (e.g., no more than 9.9994).

All disclosed numerical values are to be understood as being variable from 0-100% in either direction and thus provide support for claims that recite such values (either alone or as a minimum or a maximum—e.g., at least <value> or no more than <value>) or any ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range expressed individually (e.g., 15.2), as a minimum value (e.g., at least 4.3), or as a maximum value (e.g., no more than 12.4).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

None of the limitations in the claims should be interpreted as invoking 35 U.S.C. 112(f) unless the words “means for” or “step for” are explicitly recited in the claim.

Unless explicitly stated otherwise or otherwise apparent from context, terms such as “processing,” “computing,” “calculating,” “determining,” “displaying,” or the like, refer to the action and processes of an electronic computing device including a processor and memory.

The subject matter recited in the claims is not coextensive with and should not be interpreted to be coextensive with any embodiment, feature, or combination of features described or illustrated in this document. This is true even if only a single embodiment of the feature or combination of features is illustrated and described.

Values expressed as a concentration, percentage, or a ratio are by weight unless expressly stated otherwise.

The description of a group or class of materials as suitable or preferred for a given purpose shall be understood as disclosing that a single member of the group or class or a mixture of any two or more members of the group or class are equally suitable or preferred.

Every feature or limitation of the systems and processes described herein has been contemplated by the inventors and envisioned to be fully operable in combination with any other feature or limitation in combinations of two or more features that may not be explicitly disclosed herein as part of a single embodiment. Any feature or limitation of the inventive processes or systems described herein whether integral or optional, is to be considered fully compatible with and/or operable in combination with any other described feature or limitation unless specifically stated herein.

1. A process for monitoring a fluid to maintain the concentration of at least one molecular component of the fluid within a defined range, the process comprising:
(a) providing a fluid comprising at least two molecular components (n);
(b) selecting at least two of the molecular components in the fluid to determine the concentration of each selected molecular component;
(c) measuring at least one physical property of the fluid at a known temperature and a known pressure to produce at least one physical property measurement(s), wherein the number of physical properties measured is one less than the number of selected molecular components, wherein each physical property that is measured is distinct and correlates with the concentration of each selected molecular component;
(d) determining the concentration of each selected molecular component by:
calculating a mathematical response surface for each physical property measured in part (c), wherein each mathematical response surface represents a correlation between values for each physical property and potential concentrations of each of the selected molecular components in the fluid at a known temperature and a known pressure for the fluid,
producing an algebraic expression for each response surface that represents the correlative relationship between each physical property measured in part (c) and the possible concentrations of each selected molecular component at each value for each physical property measured in part (c),
finding the intersection between the response surface calculated for each physical property and the plane created by each physical property measurement of part (c) by setting the algebraic expression for each physical property equal to the corresponding physical property measurement to produce an algebraic equation,
solving for the resulting system of equations to derive values for the variables that are true for all equations, to produce a value for each molecular component that corresponds to the concentration of that molecular component in the fluid;
(e) comparing the concentration determined for each molecular component in (d) to a reference range of acceptable concentrations for that molecular component in the fluid;
(f) increasing the flow from at least one source that operates to increase the concentration of a selected molecular component when the concentration for that molecular component, as determined in part (d), is lower than the reference range;
(g) decreasing the flow from at least one source that operates to increase the concentration of a selected molecular component when the concentration for that component, as determined in part (d), is above the reference range.

2. The process of claim 1, wherein the concentration of an additional distinct molecular component of the fluid is inferred from the algebraic expression after the determining of part (d).

3. The process of claim 1, wherein the at least one physical property that is measured is selected from density, soundwave propagation speed, viscosity, surface tension, boiling point, freezing point, refractive index, conductivity, pH, color and opacity, heat capacity, vapor pressure and solubility.

4. The process of claim 1, wherein the known temperature is in a range wherein the fluid is in liquid phase.

5. The process of claim 1, wherein the known pressure is in a range wherein the fluid is in liquid phase.

6. The process of claim 1, wherein the temperature is in a range from 0 to 100 deg Celsius and the pressure is in the range from 1 to 100 Bara.

7. The process of claim 1, wherein the at least one source is selected from an injector and a valve.

8. The process of claim 1, wherein the physical properties are density and speed of soundwave propagation, and the molecular components are selected from hydrocarbons with a carbon number in the range from 1 to 30.

9. The process of claim 1, wherein each algebraic equation is a linear algebraic equation, wherein each response surface is a plane and wherein the intersection between the plane formed by each physical property measured in part (c) and the response surface calculated for that physical property in part (d) is a line.

10. The process of claim 1, wherein the known temperature of the fluid and the known pressure of the fluid are each measured empirically.
